(19) United States
(12) Patent Application Publication
(10) Pub. No.: US 2026/0012972 A1
(43) Pub. Date: Jan. 8, 2026

(54) WIRELESS COMMUNICATION DEVICE AND RESOURCE UNIT ALLOCATION METHOD THEREOF

(71) Applicant: Realtek Semiconductor Corporation, Hsinchu (TW)

(72) Inventors: Chung-Yao CHANG, Hsinchu (TW); Chuan-Hu LIN, Hsinchu (TW)

(21) Appl. No.: 19/234,292

(22) Filed: Jun. 11, 2025

(30) Foreign Application Priority Data
Jul. 3, 2024 (TW) 113125000

(51) Int. Cl. H04W 72/542; H04W 72/04

(52) U.S. Cl. CPC H04W 72/542; H04W 72/04

(57) ABSTRACT

A wireless communication device includes a communication module and a processor. The communication module is configured to perform radio frequency signal transmissions and receptions. The processor is coupled to the communication module and is configured to perform the following operations: performing a channel sounding procedure with another wireless communication device and receiving a channel quality indicator (CQI) feedback of 26-tone resources units in a resource unit (RU) structure from the another wireless communication device through the communication module; and performing an RU allocation on the another wireless communication device according to average signal-to-noise ratios (SNRs) in the CQI feedback, including determining a selected RU, a modulation and coding scheme (MCS) index, and a number of spatial streams for being allocated to the another wireless communication device.

### RELATED APPLICATIONS

This application claims priority to Taiwan Application Serial Number 113125000, filed Jul. 3, 2024, which is herein incorporated by reference.

### BACKGROUND

### Technical Field

The present disclosure relates to resource unit (RU) allocation for a wireless communication system, and more particularly to a wireless communication device and an RU allocation method thereof using a channel quality indicator (CQI) feedback to perform an RU allocation.

### Description of Related Art

Currently, most wireless communication systems adopt technologies such as multiple-input multiple-output (MIMO) and orthogonal frequency division multiple access (OFDMA) for enabling access points (APs) to efficiently manage bandwidth and expand throughput. The MIMO technology utilizes multiple antennas for radio frequency (RF) signal transmissions and receptions, in order to improve the overall throughput of wireless communication systems by leveraging spatial dimensions within a limited wireless channel bandwidth. The OFDMA technology allows APs to perform wireless transmissions and receptions with multiple stations (STAs) at the same time, but accordingly the complexity for allocating each STA increases. How to efficiently allocate each STA for improving system performance is one of the main goals in the related industries.

### SUMMARY

The present disclosure provides a wireless communication device which includes a communication module and a processor. The communication module is configured to receive and transmit RF signals. The processor is coupled to the communication module and is configured to perform the following operations: performing a channel sounding procedure with another wireless communication device, and receiving a CQI feedback of 26-tone RUs in an RU structure from another wireless communication device through the communication module; and performing an RU allocation on another wireless communication device according to first average SNRs in the CQI feedback, including determining a selected RU, an MCS index, and a number of spatial streams for being allocated to another wireless communication device.

The present disclosure further provides an RU allocation method which is applicable to a beamformer and includes: performing a channel sounding procedure with a beamformee, and receiving a CQI feedback of 26-tone RUs in an RU structure from the beamformee; and performing an RU allocation on the beamformee according to first average SNRs in the CQI feedback, including determining a selected RU, an MCS index, and a number of spatial streams for being allocated to the beamformee.

The present disclosure yet provides an RU allocation method which is applicable to a beamformer and includes: pre-assigning a selected RU for a beamformee; performing a channel sounding procedure with the beamformee, and receiving a CQI feedback of 26-tone RUs in an RU structure from the beamformee, in which the 26-tone RUs are covered by the selected RU; and preforming an RU allocation on the beamformee according to first average SNRs in the CQI feedback, including determining the selected RU, an MCS index, and a number of spatial streams for being allocated to the beamformee.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 exemplarily illustrates an 80 MHz RU structure.

FIG. 3 is a schematic block diagram of a wireless communication device in accordance with some embodiments of the present disclosure.

FIG. 4 is a schematic flowchart of an RU allocation method in accordance with some embodiments of the present disclosure.

FIG. 5 is a schematic flowchart of an MCS index determination method in accordance with some embodiments of the present disclosure.

FIG. 6 is a schematic flowchart of an MCS index determination method in accordance with some other embodiments of the present disclosure.

FIG. 7 is a schematic flowchart of an RU allocation method in accordance with some other embodiments of the present disclosure.

### DETAILED DESCRIPTION

The detailed explanation of the disclosure is described as follows. The described preferred embodiments are presented for purposes of illustrations and description, and they are not intended to limit the scope of the disclosure.

It will be understood that, although the terms “first,” “second,” etc., may be used herein to describe various signals, information, and/or values, these signals, information, and/or values should not be limited by these terms. These terms are only used to distinguish a signal, information, and/or value from another signal, information, and/or value.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and Extremely High Throughput (EHT) modes, in which the HT modes, the VHT modes, the HE modes, and the EHT modes respectively correspond to various generations of wireless local area networks (WLANs) such as Wi-Fi 4, Wi-Fi 5, Wi-Fi 6/6E, and Wi-Fi 7. More transmission modes are usable for a wireless communication device if the hardware specification thereof is better and the Wi-Fi system supported thereby is more advanced. The embodiments of the present disclosure may also be applied to other wired and/or wireless communication technologies such as cellular network, Bluetooth, local area network (LAN) and/or Universal Serial Bus (USB).

In the present disclosure, the beamformer and the beamformee may be an access point and a station in a wireless communication system, respectively, or a station and a wireless in a wireless communication system, respectively, but is not limited thereto. The 26-tone RU is an RU that includes 26 subcarriers, and can be denoted as an RU RU26 in the context. Likewise, the 52-tone RU is an RU that includes 52 subcarriers, and can be denoted as an RU RU52 in the context, and so on.

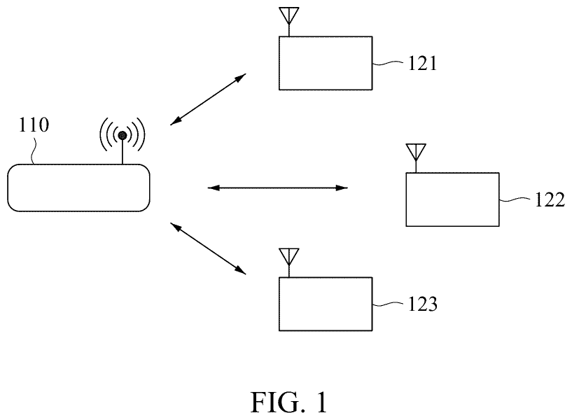

FIG. 1 is a schematic diagram of a wireless communication system 100 in accordance with some embodiments of the present disclosure. The wireless communication system 100 includes a wireless access point device 110 and wireless station devices 121-123. The wireless access point device 110 provides wireless access services within a certain range, and each of the wireless station devices 121-123 may perform a wireless communication connection with the wireless access point device 110 through a Wi-Fi channel (e.g., an IEEE 802.11 channel) to access a local area network and/or an external network (e.g., the Internet). The wireless communication connection between the wireless access point device 110 and any of the wireless station devices 121-123 may include, but not limited to, a registration procedure, an authentication procedure and an access procedure, establishment and release of a wireless connection, and transmissions and/or receptions of control signals and/or transmissions and/or receptions of data signals. Each of the wireless station devices 121-123 may be, for example, a smartphone, a tablet, a notebook, or another device with wireless signal transmission and reception functions. In addition, the wireless access point device 110 may be, for example, a wireless router, a wireless switch, or a wireless station device with access point functions. In other embodiments, the wireless station devices 121-123 may have access point functions. It should be noticed that the number of wireless station devices in the present disclosure is not limited to that shown in FIG. 1.

The wireless communication system 100 may support the OFDMA technology. In the wireless communication system 100, the wireless access point device 110 may separate a wireless channel resource with a particular bandwidth into plural RUs, and allocate RUs corresponding to the wireless station devices 121-123, such that the frequency bands used by the wireless station devices 121-123 for signal transmissions and receptions are not overlapped with each other at the same time. In addition, the wireless communication system 100 may support the technologies of MIMO, multiple-input single-output (MISO), single-input multiple-output (SIMO), and/or single-input single-output (SISO). Taking that the MIMO technology is supported as an example, the wireless access point device 110 may perform beamforming with the wireless station devices 121-123, including that the wireless access point device 110 transmits a sounding signal to the wireless station devices 121-123, that the wireless station devices 121-123 perform channel estimation and feedback channel information to the wireless access point device 110, and that the wireless access point device 110 establishes beamforming steering matrices respectively corresponding to the wireless station devices 121-123 for signal transmissions and receptions with the wireless station devices 121-123.

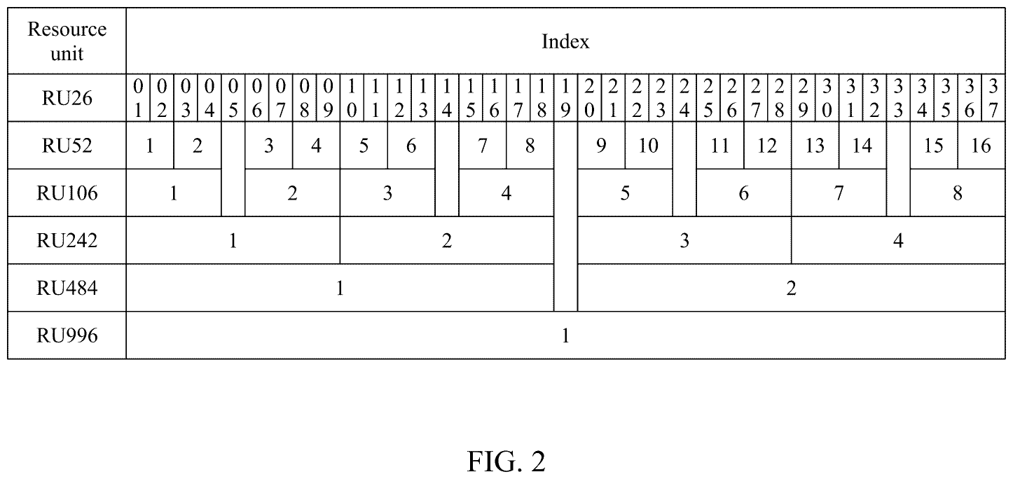

FIG. 2 exemplarily illustrates an 80 MHz RU structure which complies with the WLAN standards. As shown in FIG. 2, the 80 MHz RU structure includes 37 RUs RU26 (respectively with the indices of 1-37), 16 RUs RU52 (respectively with the indices of 1-16), 8 RUs RU106 (respectively with the indices of 1-8), 4 RUs RU242 (respectively with the indices of 1-4), 2 RUs RU484 (respectively with the indices of 1-2), and 1 RU RU996 (with the index of 1). The allocated RU may be any of the abovementioned RUs. Each of the RUs RU52, RU106, RU242, RU484, and RU996 covers at least two RUs RU26, and the RUs with the same number of subcarriers are not overlapped with each other. For example, the RU RU242 with the index of 1 covers the RUs RU26 respectively with the indices of 1-9, the RU RU242 with the index of 2 covers the RUs RU26 respectively with the indices of 10-18, and these two RUs RU242 are not overlapped with each other.

The wireless access point device 110 may allocate RUs with different indices and different numbers of subcarriers for the wireless station devices 121-123 according to the RU structure shown in FIG. 2, e.g., allocating the RUs RU242 with the indices of 1-3 respectively for the wireless station devices 121-123, or allocating the RUs RU242 with the indices of 1 and 2 respectively for the wireless station devices 121, 122 and allocating the RU RU484 with the index of 2 for the wireless station device 123, but the present disclosure is not limited thereto.

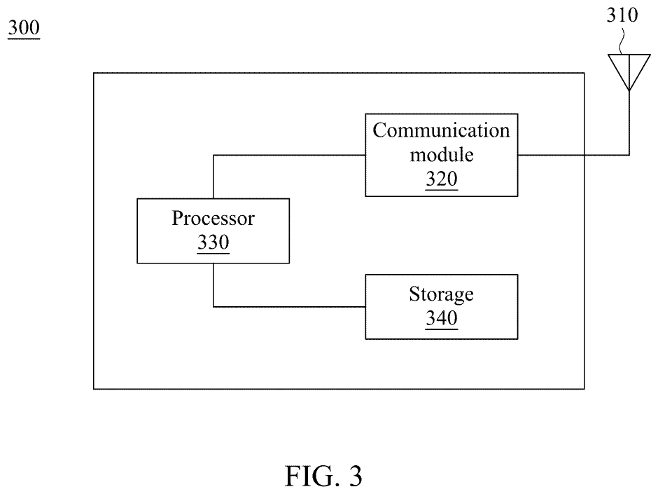

FIG. 3 is a schematic block diagram of a wireless communication device 300 in accordance with some embodiments of the present disclosure. The wireless communication device 300 may be any of the wireless access point device 110 and the wireless station devices 121-123 in FIG. 1, or any wireless communication device that can be a beamformer. The wireless communication device 300 includes an antenna 310, a communication module 320, a processor 330, and a storage 340. The antenna 310 is configured to perform wireless transmissions and receptions by transmitting and receiving RF signals. In some embodiments, the wireless communication device 300 may include plural antennas 310 that may be configured to perform multiple-input and/or multiple-output RF signal transmissions and receptions. The communication module 320 is coupled to the antenna 310 and is configured for RF signal transmissions and receptions, such as receiving and demodulating RF signals into packets (e.g., control signals or data signals) and modulating packets that are to be transmitted into RF signals. The processor 330 is coupled to the communication module 320 and the storage 340 and is configured to process packets and determine the transmission mode of the communication module 320 according to the system status for performing signal transmissions and receptions. The processor 330 may be, for example, but not limited to, a microprocessor or an application-specific integrated circuit (ASIC). The storage 340 may be any data storage device that can be read and executed by the processor 330. The storage 340 may be, for example, but not limited to, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk drive, a solid-state drive, a flash memory, or another data storage device suitable for storing bit data and/or program codes.

In particular, the processor 330 may be configured to perform the following operations. In the beginning, the processor 330 preforms a channel sounding procedure with another wireless communication device and receives a CQI feedback of RUs RU26 in an RU structure such another wireless communication device through the communication module 320. Then, the processor 330 performs an RU allocation on such another wireless communication device according to average signal-to-noise ratios (SNRs) in the CQI feedback, including a selected RU, an MCS index, and the number of spatial streams for being allocated to such another wireless communication device. After completing the RU allocation, the processor 330 may transmit a frame including the selected RU, the MCS index, and the number of spatial streams to such another wireless communication device through the communication module 320. Details of performing an RU allocation are described in the following description.

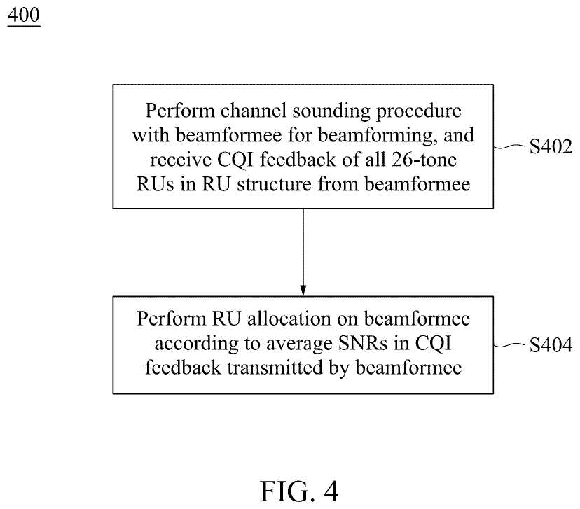

FIG. 4 is a schematic flowchart of an RU allocation method 400 in accordance with some embodiments of the present disclosure. The RU allocation method 400 is applicable to the wireless access point device 110 of the wireless communication system 100 in FIG. 1, the wireless communication device 300 in FIG. 3, and/or another device that can be as a beamformer. The RU allocation method 400 is performed by a beamformer, e.g., performed by the processor 330 of the wireless communication device 300, and includes the following operations. In the beginning, Operation S402 is performed to perform a channel sounding procedure with a beamformee for beamforming, and to receive the CSI feedback of all 26-tone RUs (RU26) in the RU structure from the beamformee. The RU structure may be, for example, the 80 MHz RU structure shown in FIG. 2, or a 160 MHz or an 80 MHz+80 MHz RU structure, but is not limited thereto.

The CQI feedback transmitted by the beamformee includes the per-stream SNRs of the RUs RU26 received by the beamformee. The channel response received by the beamformee is represented by a channel response matrix H, which is the addition of the MIMO channel response matrix H between the beamformee and the beamformer and a Gaussian noise matrix n (i.e., Hᵣ=H+n, where the sizes of H, n are all Nᵣ×Nₜ, Nᵣ is the number of antennas of the beamformee, and N is the number of antennas of the beamformer), and a singular value decomposition (SVD) performed on the channel response matrix H, is shown in Equation (1):

$${H}_{r} = U ( S + {σ}_{n} I ) {V}^{*} , \qquad ( 1 )$$

where U and V are an Nᵣ×Nᵣ unitary matrix and an Nₜ×Nₜ unitary matrix, respectively), S=diag (σ₁, σ₂, . . . , σ_{N}_{_{c}}) is an Nᵣ×Nₜ diagonal matrix (rectangular diagonal matrix or square diagonal matrix), σ₁−σ_{N}_{_{c}} are the singular values of the diagonal matrix S, I is an Nᵣ×Nₜ unitary matrix (rectangular unitary matrix or square unitary matrix), V* is the conjugate transpose of the matrix V (conjugate transpose), N_{c} is the smallest one between the number of antennas Nᵣ of the beamformee and the number of antennas Nₜ of the beamformer (i.e., N_{c}=min(Nᵣ, Nₜ)), and σₙ is the square root of the Gaussian noise power.

When both the beamformer and the beamformee apply the beamforming rule, the beamformed channel response is H′ᵣ=U*HᵣV=(S+σₙI). According to the definition of SNR, the average SNR AvgSNRᵢ of the i^{th} stream (i is the stream index) is as expressed in Equation (2):

$${AvgSNR}_{i} = 10 {log}_{10} ( \frac{{σ}_{i}^{2}}{{σ}_{n}^{2}} ) . \qquad ( 2 )$$

The channel condition number CN is defined as the decibel difference between the largest singular value and the smallest singular value, which is as expressed in Equation (3):

$$C N = 20 {log}_{10} \{ \frac{max ( {σ}_{1} , {σ}_{2} , … , {σ}_{{N}_{c}} )}{min ( {σ}_{1} , {σ}_{2} , … , {σ}_{{N}_{c}} )} \} = 10 {log}_{10} \{ \frac{max ( {σ}_{1}^{2} , {σ}_{2}^{2} , … , {σ}_{{N}_{C}}^{2} )}{min ( {σ}_{1}^{2} , {σ}_{2}^{2} , … , {σ}_{{N}_{C}}^{2} )} \} . \qquad ( 3 )$$

By dividing the numerator and the denominator in Equation (3) by the noise power

$${σ}_{n}^{2} ,$$

can be obtained as follows:

$$CN = {max}_{i = 1 , 2 , … , {N}_{c}} ( {AvgSNR}_{i} ) - {min}_{i = 1 , 2 , … , {N}_{c}} ( {AvgSNR}_{i} ) . \qquad ( 4 )$$

Consequently, the corresponding channel condition number can be derived from the given per-stream average SNRs according to Equation (4).

Based on the above description, the beamformee may obtain the average SNRs of all streams in the RU RU26 with the index of k (including the average SNRs AvgSNR_{k, 1}−AvgSNR_{k, N}_{_{c}} of the 1^{st} to N_{c}^{th} streams), and may transmit a CQI feedback including the average SNRs to the beamformer according to the request of the beamformer.

Then, Operation S404 is performed to perform an RU allocation on the beamformee according to the average SNRs in the CQI feedback that is transmitted from the beamformee, including a selected RU, an MCS index, and the number of spatial streams for being allocated to the beamformee. In some embodiments, the beamformer allocates an RU RU26 for the beamformee. In some other embodiments, the beamformer allocates an RU other than an RU RU26 for the beamformee (for example, but not limited to, an RU RU52, RU106, RU242, RU484, or RU996).

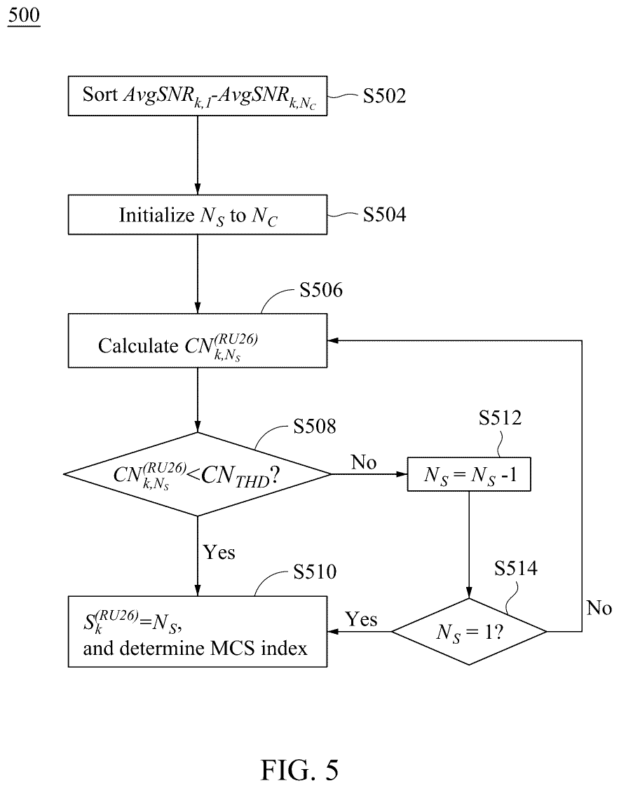

FIG. 5 is a schematic flowchart of an MCS index determination method 500 in accordance with some embodiments of the present disclosure. The MCS index determination method 500 is used for a beamformer to allocate an RU RU26 for a beamformee. In the beginning, Operation S502 is performed to sort the average SNRs AvgSNR_{k,1}−AvgSNR_{k, N}_{_{c}} of the 1^{st} to the N_{c}^{th} streams to obtain sorted average

$$SNRs {AvgSNR}_{k}^{1} - {AvgSNR}_{k}^{{N}_{c}} , where {AvgSNR}_{k}^{j} > {AvgSNR}_{k}^{j + 1} ,$$

and j=1, 2, . . . , N_{c}−1.

Then, Operation S504 is performed to initialize the number of spatial streams Nₛ as N_{c}, and subsequently Operation S506 is performed to calculate the channel condition number

$$C {N}_{k , {N}_{s}}^{( R U 26 )}$$

Corresponding to the RU RU26 with the index of k. By imparting a number of spatial streams Nₛ (Nₛ=2, 3, . . . , N_{c}−1) to the RU RU26 with the index of k, the channel condition number

$$C {N}_{k , {N}_{s}}^{( R U 26 )}$$

corresponding to the RU RU26 is shown in Equation (5):

$$C {N}_{k , {N}_{S}}^{( R U 26 )} = {AvgSNR}_{k}^{1} - {AvgSNR}_{k}^{{N}_{s}} . \qquad ( 5 )$$

Afterwards, Operation S508 is performed to determine whether the channel condition number

$$C {N}_{k , {N}_{s}}^{( R U 26 )}$$

is less than a predetermined threshold CN_{THD}. If the channel condition number

$$C {N}_{k , {N}_{s}}^{( R U 26 )}$$

is less than the predetermined threshold CN_{THD}, Operation S510 is performed to have the number of spatial streams

$${S}_{k}^{( RU 26 )}$$

equal to the number of spatial streams Nₛ, and to determine the MCS index MCS_RU26ₖ of the RU RU26 with the index of k accordingly. Otherwise, Operation S512 is performed, in which the number of spatial streams Nₛ is decremented by 1 (Nₛ=Nₛ−1), and then Operation S514 is performed to determine whether the number of spatial streams Nₛ is equal to 1. If the number of spatial streams Nₛ is equal to 1, Operation S510 is performed to have the number of spatial streams

$${S}_{k}^{( RU 26 )}$$

equal to the number of spatial streams Nₛ, and to determine the MCS index MCS_RU26, of the RU RU26 with the index of k accordingly. Otherwise, if the number of spatial streams Nₛ is not equal to 1, the MCS index determination method 500 goes back to Operation S506 to recalculate the channel condition number

$$C {N}_{k , {N}_{s}}^{( R U 26 )}$$

and determine the channel condition number

$$C {N}_{k , {N}_{s}}^{( R U 26 )}$$

to be less that the predetermined threshold CN_{THD}.

If the RU allocation performed on the beamformee is an allocation of an RU RU26, the MCS index MCS_RU26, corresponding to the index of k can be determined directly depending on the number of spatial streams

$${S}_{k}^{( RU 26 )} .$$

Each RU RU26 includes 26 subcarriers, and the subcarrier spacing is 78.125 KHz (can be regarded as a flat narrowband channel), and thus the MCS index can be selected depending on the Gaussian noise. Table 1 is a mapping table between required SNRs and MCS indices in a Gaussian noise environment in accordance with the IEEE 802.11be Standard. According to the number of spatial streams

$${S}_{k}^{( RU 26 )}$$

obtained at Operation S510, the average

$$SNR {AvgSNR}_{k}^{{N}_{s}} ( {N}_{s} = {S}_{k}^{( RU 26 )} )$$

can be selected from the average

$$SNRs {AvgSNR}_{k}^{1} - {AvgSNR}_{k}^{{N}_{c}} ,$$

and then the MCS index MCS_RU26ₖ can be determined depending on the mapping table shown in Table 1, which is the greatest one of the candidate MCS indices that map to all required SNR not higher than the average

$$SNR {AvgSNR}_{k}^{{N}_{s}} .$$

For example, if the average

$$SNR {AvgSNR}_{k}^{{N}_{s}}$$

is 10, according to the mapping table shown in Table 1, the determined MCS index is 3; if the average

$$SNR {AvgSNR}_{k}^{{N}_{s}}$$

is 17.5, according to the mapping table shown in Table 1, the determined MCS index is 6. By selecting the lowest required SNR in the spatial streams (with the number of spatial streams Nₛ) as the upper limit of the MCS index, successful receiving of all spatial stream data in a single MCS index can be ensured.

TABLE 1

| Candidate MCS index | 0 | 1 | 2 | 3 | 4 | 5 | 6 |
|---|---|---|---|---|---|---|---|
| Required SNR | 0.75 | 3.50 | 6.00 | 8.75 | 12.00 | 15.75 | 17.50 |
| Candidate MCS index | 7 | 8 | 9 | 10 | 11 | 12 | 13 |
| Required SNR | 18.50 | 23.90 | 24.00 | 27.75 | 29.50 | 33.25 | 35.25 |

The average SNRs AvgSNR_{k, 1}−AvgSNR_{k, N}_{_{c}} and the number of spatial streams

$${S}_{k}^{( RU 26 )}$$

of the RUs RU26 described above may also be used to select a required SNR of another RU (for example, but not limited to, the RU RU52, the RU RU104, the RU RU242, the RU RU484, and the RU RU996).

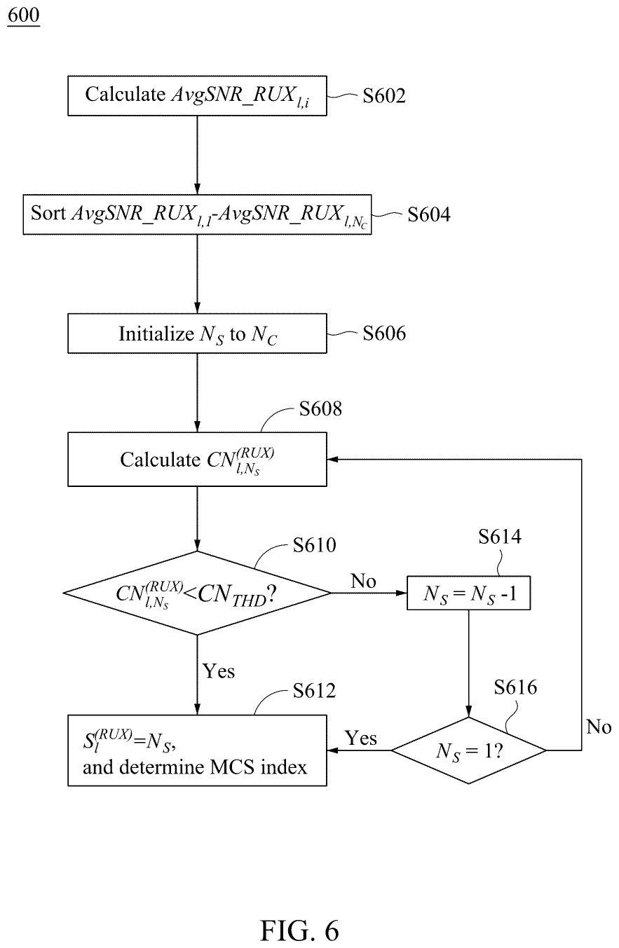

FIG. 6 is a schematic flowchart of an MCS index determination method 600 in accordance with some other embodiments of the present disclosure. The MCS index determination method 600 is used for a beamformer to allocate an RU RUX (where X is the number of subcarriers, e.g., 52, 104, 242, 484, and 996, but not 26) for a beamformee. In the beginning, Operation S602 is performed to calculate the average SNR AvgSNR_RUX_{l, i} of the i^{th} stream (i is the stream index) in the RU RUX (where X is the number of subcarriers, e.g., 52) with the index of l, as shown in Equation (6):

$${AvgSNR\_RUX}_{I , i} = 10 {log}_{10} [ \frac{1}{n} {\sum }_{k = m}^{m + n} {10}^{( {AvgSNR}_{k , i} / 10 )} ] , \qquad ( 6 )$$

where i=1, 2, . . . , N_{c},AvgSNR_{k, i} is the average SNR of the i^{th} stream in the RU RU26 with the index of k, and m, n are determined from the number of subcarriers X and the index l. For example, as can be seen from FIG. 2, m, n corresponding to the RU RU242 with the index of 2 are 10 and 8, respectively (i.e., the RUs RU26 respectively corresponding to the indices of 10 to 18).

Then, Operation S604 is performed to sort the average SNRs AvgSNR_RUX_{l, 1}−AvgSNR_RUX_{l, N}_{_{c}} of all streams to obtain sorted average

$$SNRs {AvgSNR\_RUX}_{I}^{1} - {AvgSNR\_RUX}_{I}^{{N}_{c}} , where {AvgSNR\_RUX}_{I}^{j} > {AvgSNR\_RUX}_{I}^{j + 1} , and j = 1 , 2 , … , {N}_{c} - 1.$$

Afterwards, Operation S606 is performed to initialize the number of spatial streams Nₛ, as shown in Equation (7):

$${N}_{s} = {min}_{k = m , m + 1 , … , m + n} {S}_{k}^{( RU 26 )} , \qquad ( 7 )$$

and then Operation S608 is performed to calculate the channel condition number

$${CN}_{I , {N}_{s}}^{( RUX )}$$

corresponding to the RU RUX with the index of l. The calculation of the number of spatial streams

$${S}_{k}^{( RU 26 )}$$

can be referred to the description of FIG. 5 and is not repeated herein. By importing a number of spatial streams Nₛ (Nₛ=2, 3, . . . , N_{c}−1) to the RU RUX with the index of l, the channel condition number

$${CN}_{I , {N}_{s}}^{( RUX )}$$

corresponding to the RU RUX is shown in Equation (8):

$${CN}_{I , {N}_{s}}^{( RUX )} = {AvgSNR\_RUX}_{I}^{1} - {AvgSNR\_RUX}_{I}^{{N}_{s}} . \qquad ( 8 )$$

Afterwards, Operation S610 is performed to determine whether the channel condition number

$${CN}_{I , {N}_{s}}^{( RUX )}$$

is less than the predetermined threshold CN_{THD}. If the channel condition number

$$C {N}_{I , {N}_{s}}^{( RUX )}$$

is less than the threshold CN_{THD}, Operation S612 is performed to have the number of spatial streams

$${S}_{I}^{( RUX )}$$

equal to the number of spatial streams Nₛ and to determine the MCS index MCS_RUXₗ of the RU RUX with the index of l accordingly. Otherwise, Operation S614 is performed to decrement the number of spatial streams Nₛ by 1 (Nₛ=Nₛ−1), and subsequently Operation S616 is performed to determine whether the number of spatial streams Nₛ is equal to 1. If the number of spatial streams Nₛ is equal to 1, Operation S612 is performed to have the number of spatial streams

$${S}_{I}^{( RUX )}$$

equal to the number of spatial streams Nₛ and to determine the MCS index MCS_RUXₗ corresponding to the RU RUX with the index of l. On the contrary, if the number of spatial streams Nₛ is not equal to 1, the MCS index determination method 600 goes back to Operation S608 to recalculate the channel condition number

$$C {N}_{I , {N}_{s}}^{( RUX )}$$

and determine the channel condition number

$$C {N}_{I , {N}_{s}}^{( RUX )}$$

to be less than the predetermined threshold CN_{THD}.

Similarly, according to the number of spatial streams

$${S}_{I}^{( RUX )}$$

obtained at Operation S612, the average

$${SNRsAvgSNR\_RUX}_{I}^{{N}_{s}} ( {N}_{s} = {S}_{I}^{( RUX )} )$$

can be selected from the average

$${SNRsAvgSNR\_RUX}_{I}^{1} - {AvgSNR\_RUX}_{I}^{{N}_{c}} ,$$

and then the MCS index MCS_RUXₗ is determined the mapping table shown in Table 1, which is the greatest one of the candidate MCS indices that map to all required SNRs not higher than the average

$${SNRAvgSNR\_RUX}_{I}^{{N}_{s}} .$$

In comparison with using a multipath mapping table to select an MCS index, the MCS index determination method 600 utilizes a Gaussian noise mapping table with significantly low complexity (e.g., the mapping table shown in Table 1) to select an MCS index in combination with the number of spatial streams of the RU RU26 being an initial upper limit, successful receiving of all spatial stream data in a single MCS index can also be ensured.

Referring back to FIG. 4, if Operation S404 is to allocate an RU RU26 for the beamformee, the MCS index determination method 500 may be applied to determine the MCS index. Oppositely, if Operation S404 is to allocate the RU RUX for the beamformee, the MCS index determination method 600 may be applied to determine the MCS index. By performing the MCS index determination method 500 or 600 to obtain the number of spatial streams

$${S}_{p}^{( RUY )}$$

(i.e., the number of spatial streams

$${S}_{k}^{( R U 26 )} or {S}_{I}^{( RUX )} ,$$

where ρ is the index of the RU RUY) of all RUs RUY (for example, but not limited to, the RUs RU26, RU52, RU104, RU242, RU484 or RU996) and determine the MCS index MCS_RUYₚ (i.e., the MCS index MCS_RU26ₖ or the MCS index MCS_RUXₗ), management of RU allocation for configuring the beamformee can be further performed, thereby achieving optimal traffic performance.

In specific, the total number of encoded bits N_RUY_{p, total} that can be transmitted in the RU RUY with the index of p is shown in Equation (9):

$${N\_RUY}_{p , total} = {N\_RUY}_{D A T A} \times {N\_RUY}_{p , BPSCS} \times {S}_{p}^{( R U Y )} , \qquad ( 9 )$$

where N_RUY_{p, BPSCS} is the number of decoded bits per subcarrier and per stream of the RU RUY with the index of p, which is associated with the MCS index MCS_RUYₚ (for example, according to the IEEE 802.11be Standard, the number of decoded bits corresponding to the MCS indices of 3 and 4 is 4, and the number of decoded bits corresponding to the MCS indices of 12 and 13 is 12), and N_RUY_{DATA} is the number of data tones of the RU RUY. Then, the RU RUY with the index of \hat{p} and the greatest total number of encoded bits from all RUs RUY is determined as a selected RU, as shown in Equation (10):

$$\hat{p} = {arg max}_{〈 p 〉} {N\_RUV}_{p , total} , \qquad ( 10 )$$

where [symbol] p [symbol] represents the set of all possible index p for the RU RUY (i.e., the set of all candidate RUs). Accordingly, the selected RU, the MCS index, and the number of spatial streams for being allocated to the beamformee are determined as the RU RUY with the index of \hat{p}, the MCS index MCS_RUY_{\hat{p}}, and the number of spatial streams

$${S}_{\hat{p}}^{( RUY )} ,$$

respectively. Afterwards, the beamformer may transmit a frame including information such as the RU RUY with the index of \hat{p}, the MCS index MCS_RUY_{\hat{p}}, and the number of spatial streams

$${S}_{\hat{p}}^{( RUY )}$$

to the beamformee, in order to instruct the beamformee to perform subsequent wireless signal transmissions and receptions accordingly.

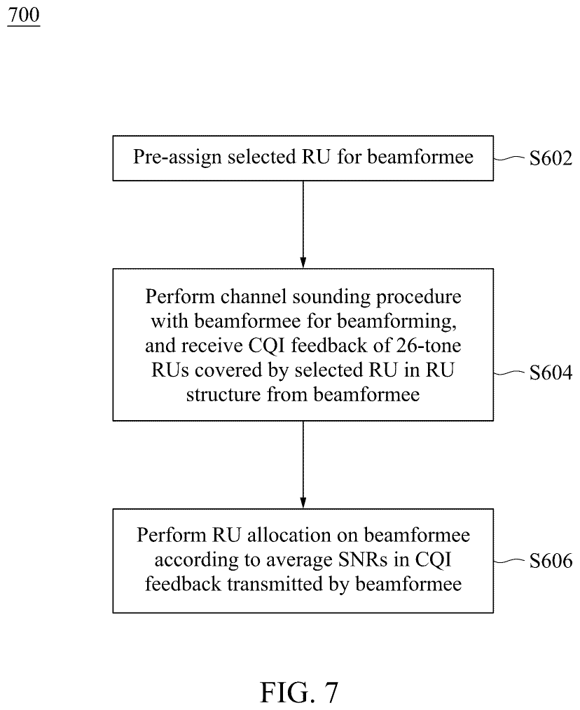

FIG. 7 is a schematic flowchart of an RU allocation method 700 in accordance with some other embodiments of the present disclosure. The RU allocation method 700 is applicable to the wireless access point device 110 of the wireless communication system 100 in FIG. 1, the wireless communication device 300 in FIG. 3, and/or another device that can be as a beamformer. The RU allocation method 700 is performed by a beamformer, e.g., performed by the processor 330 of the wireless communication device 300, and includes the following operations. First, Operation S702 is performed to pre-assign a selected RU for a beamformee, e.g., assign an RU RU242 with the index of 2, but is not limited thereto. Then, Operation S704 is performed to perform a channel sounding procedure with the beamformee for beamforming and receive a CQI feedback of the RUs RU26 covered by the selected RU in the RU structure from the beamformee. Similarly, the RU structure may be, for example, the 80 MHz RU structure shown in FIG. 2, or a 160 MHz or an 80 MHz+80 MHz RU structure, but is not limited thereto.

Afterwards, Operation S706 is performed to perform an RU allocation on the beamformee according to the average SNRs in the CQI feedback from the beamformee, which includes determining the selected resource, the MCS index, and the number of spatial streams for being allocated to the beamformee. The beamformer may allocate an RU other than an RU RU26 (for example, but not limited to, an RU RU52, RU106, RU242, RU484, or RU996) for the beamformee.

The different between Operation S702 and the RU allocation method 400 is, at Operation S702, the beamformer pre-assigns a selected RU for the beamformee before performing a channel sounding procedure with the beamformee, and thus the beamformee merely needs to transmit a CQI feedback including average SNRs of all streams corresponding to a particular RU to the beamformer based on the requirement of the beamformer. The selected RU pre-assigned for the beamformee may cover plural RUs RU26. Taking an RU structure with a bandwidth of 80 MHz for example, if the beamformer pre-assigns an RU RU242 with the index of 1 for the beamformee, according to the RU structure shown in FIG. 2, the beamformee needs to merely transmit a CQI feedback including the average SNRs of all streams of RUs RU26 respectively with the indices of 1-9 to the beamformer. If the beamformer pre-assigns an RU RU242 with the index of 1 for the beamformee, according to the RU structure shown in FIG. 2, the beamformee needs to merely transmit a CQI feedback including the average SNRs of the beamformer pre-assigns an RU RU242 with the index of 2 for the beamformee, according to the RU structure shown in FIG. 2, the beamformee needs to merely transmit a CQI feedback including the average SNRs of all streams of RUs RU26 respectively with the indices of 10-18 to the beamformer. Accordingly, the beamformer does not need to determine an RU with the greatest total number of encoded bits from all RUs with the same number of subcarriers as a selected RU. The calculation of the average SNRs at the beamformee can be referred to the aforementioned description of FIG. 4 and is not repeated herein.

In some embodiments, the RU allocation method 400 and/or 700 and/or the MCS index determination method 500 and/or 600 may be applicable to the wireless communication device 300, and may be programmed into program codes that are stored in the storage 340 and are executed by the processor 330 accessing the storage 340.

Summarizing the above description, the present disclosure provides a wireless communication device which includes a communication module and a processor. The communication module is configured to receive and transmit RF signals. The processor is coupled to the communication module and is configured to perform the following operations: performing a channel sounding procedure with another wireless communication device, and receiving a CQI feedback of 26-tone RUs in an RU structure from another wireless communication device through the communication module; and performing an RU allocation on another wireless communication device according to first average SNRs in the CQI feedback, including determining a selected RU, an MCS index, and a number of spatial streams for being allocated to another wireless communication device. In one embodiment, a bandwidth of the RU structure is 80 MHz. In one embodiment, the selected RU is one of the 26-tone RUs. In one embodiment, the MCS index is a greatest one of candidate MCS indices, and the candidate MCS indices map to required SNRs not higher than one of the first average SNRs corresponding to the selected RU. In one embodiment, the selected RU is a 52-tone RU, a 106-tone RU, a 242-tone RU, a 484-tone RU, or a 996-tone RU, and the selected RU covers at least two of the 26-tone RUs. In one embodiment, the operation of determining the selected RU for being allocated to another wireless communication device by the processor includes: calculating second average SNRs of candidate RUs according to the first average SNRs, in which each candidate RU covers at least two of the 26-tone RUs; determining the selected RU from the candidate RUs, in which a number of subcarriers of each candidate RU is identical to a number of subcarriers of the selected RU; and determining the MCS index as a greatest one of candidate MCS indices, in which the candidate MCS indices map to required SNRs not higher than one of the second average SNRs corresponding to the selected RU. In one embodiment, the processor is further configured to pre-assign the selected RU for another wireless communication device before performing the channel sounding procedure with another wireless communication device, and the selected RU covers the 26-tone RUs. In one embodiment, the processor is further configured to transmit a frame including the selected RU, the MCS index, and the number of spatial streams to another wireless communication device through the communication module.

Summarizing the above description, the present disclosure further provides an RU allocation method which is applicable to a beamformer and includes: performing a channel sounding procedure with a beamformee, and receiving a CQI feedback of 26-tone RUs in an RU structure from the beamformee; and performing an RU allocation on the beamformee according to first average SNRs in the CQI feedback, including determining a selected RU, an MCS index, and a number of spatial streams for being allocated to the beamformee. In one embodiment, a bandwidth of the RU structure is 80 MHz. In one embodiment, the selected RU is one of the 26-tone RUs. In one embodiment, the MCS index is a greatest one of candidate MCS indices, and the candidate MCS indices map to required SNRs not higher than one of the first average SNRs corresponding to the selected RU. In one embodiment, the selected RU is a 52-tone RU, a 106-tone RU, a 242-tone RU, a 484-tone RU, or a 996-tone RU, and the selected RU covers at least two of the 26-tone RUs. In one embodiment, determining the selected RU for being allocated to the beamformee includes: calculating second average SNRs of candidate RUs according to the first average SNRs, in which each candidate RU covers at least two of the 26-tone RUs; determining the selected RU from the candidate RUs, in which a number of subcarriers of each candidate RU is identical to a number of subcarriers of the selected RU; and determining the MCS index as a greatest one of candidate MCS indices, in which the candidate MCS indices map to required SNRs not higher than one of the second average SNRs corresponding to the selected RU. In one embodiment, the RU allocation method further includes transmitting a frame including the selected RU, the MCS index, and the number of spatial streams to the beamformee.

Summarizing the above description, the present disclosure yet provides an RU allocation method which is applicable to a beamformer and includes: pre-assigning a selected RU for a beamformee; performing a channel sounding procedure with the beamformee, and receiving a CQI feedback of 26-tone RUs in an RU structure from the beamformee, in which the 26-tone RUs is covered by the selected RU; and preforming an RU allocation on the beamformee according to first average SNRs in the CQI feedback, including determining the selected RU, an MCS index, and a number of spatial streams for being allocated to the beamformee. In one embodiment, a bandwidth of the RU structure is 80 MHz. In one embodiment, the selected RU is a 52-tone RU, a 106-tone RU, a 242-tone RU, a 484-tone RU, or a 996-tone RU. In one embodiment, determining the selected RU for being allocated to the beamformee includes: calculating a second average SNR of the selected RU according to the first average SNRs; and determining the MCS index as a greatest one of candidate MCS indices, in which the candidate MCS indices map to required SNRs not higher than the second average SNR. In one embodiment, the RU allocation method further includes transmitting a frame including the selected RU, the MCS index, and the number of spatial streams to the beamformee.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A wireless communication device, comprising:
a communication module configured to receive and transmit radio frequency (RF) signals; and
a processor coupled to the communication module and configured to perform the following operations:
performing a channel sounding procedure with another wireless communication device, and receiving a channel quality indicator (CQI) feedback of a plurality of 26-tone resource units (RUs) in an RU structure from the another wireless communication device through the communication module; and
performing an RU allocation on the another wireless communication device according to a plurality of first average signal-to-noise ratios (SNRs) in the CQI feedback, including determining a selected RU, a modulation and coding scheme (MCS) index, and a number of spatial streams for being allocated to the another wireless communication device.

2. The wireless communication device of claim 1, wherein a bandwidth of the RU structure is 80 MHz.

3. The wireless communication device of claim 1, wherein the selected RU is one of the plurality of 26-tone RUs.

4. The wireless communication device of claim 3, wherein the MCS index is a greatest one of a plurality of candidate MCS indices, and wherein the plurality of candidate MCS indices map to a plurality of required SNRs not higher than one of the plurality of first average SNRs corresponding to the selected RU.

5. The wireless communication device of claim 1, wherein the selected RU is a 52-tone RU, a 106-tone RU, a 242-tone RU, a 484-tone RU, or a 996-tone RU, and wherein the selected RU covers at least two of the plurality of 26-tone RUs.

6. The wireless communication device of claim 5, wherein the operation of determining the selected RU for being allocated to the another wireless communication device by the processor comprises:
calculating a plurality of second average SNRs of a plurality of candidate RUs according to the plurality of first average SNRs, wherein each of the plurality of candidate RUs covers at least two of the plurality of 26-tone RUs;
determining the selected RU from the plurality of candidate RUs, wherein a number of subcarriers of each of the plurality of candidate RUs is identical to a number of subcarriers of the selected RU; and
determining the MCS index as a greatest one of a plurality of candidate MCS indices, wherein the plurality of candidate MCS indices map to a plurality of required SNRs not higher than one of the plurality of second average SNRs corresponding to the selected RU.

7. The wireless communication device of claim 1, wherein the processor is further configured to pre-assign the selected RU for the another wireless communication device before performing the channel sounding procedure with the another wireless communication device, and wherein the selected RU covers the plurality of 26-tone RUs.

8. The wireless communication device of claim 1, wherein the processor is further configured to transmit a frame including the selected RU, the MCS index, and the number of spatial streams to the another wireless communication device through the communication module.

9. An RU allocation method applicable to a beamformer, the RU allocation method comprising:
performing a channel sounding procedure with a beamformee, and receiving a CQI feedback of a plurality of 26-tone RUs in an RU structure from the beamformee; and
performing an RU allocation on the beamformee according to a plurality of first average SNRs in the CQI feedback, including determining a selected RU, an MCS index, and a number of spatial streams for being allocated to the beamformee.

10. The RU allocation method of claim 9, wherein a bandwidth of the RU structure is 80 MHz.

11. The RU allocation method of claim 9, wherein the selected RU is one of the plurality of 26-tone RUs.

12. The RU allocation method of claim 11, wherein the MCS index is a greatest one of a plurality of candidate MCS indices, and wherein the plurality of candidate MCS indices map to a plurality of required SNRs not higher than one of the plurality of first average SNRs corresponding to the selected RU.

13. The RU allocation method of claim 9, wherein the selected RU is a 52-tone RU, a 106-tone RU, a 242-tone RU, a 484-tone RU, or a 996-tone RU, and the selected RU covers at least two of the plurality of 26-tone RUs.

14. The RU allocation method of claim 13, wherein determining the selected RU for being allocated to the beamformee comprises:
calculating a plurality of second average SNRs of a plurality of candidate RUs according to the plurality of first average SNRs, wherein each of the plurality of candidate RUs covers at least two of the plurality of 26-tone RUs;
determining the selected RU from the plurality of candidate RUs, wherein a number of subcarriers of each of the plurality of candidate RUs is identical to a number of subcarriers of the selected RU; and
determining the MCS index as a greatest one of a plurality of candidate MCS indices, wherein the plurality of candidate MCS indices map to a plurality of required SNRs not higher than one of the plurality of second average SNRs corresponding to the selected RU.

15. The RU allocation method of claim 9, further comprising:
transmitting a frame including the selected RU, the MCS index, and the number of spatial streams to the beamformee.

16. An RU allocation method applicable to a beamformer, the RU allocation method comprising:
pre-assigning a selected RU for a beamformee;
performing a channel sounding procedure with the beamformee, and receiving a CQI feedback of a plurality of 26-tone RUs in an RU structure from the beamformee, wherein the plurality of 26-tone RUs are covered by the selected RU; and
preforming an RU allocation on the beamformee according to a plurality of first average SNRs in the CQI feedback, including determining the selected RU, an MCS index, and a number of spatial streams for being allocated to the beamformee.

17. The RU allocation method of claim 16, wherein a bandwidth of the RU structure is 80 MHz.

18. The RU allocation method of claim 16, wherein the selected RU is a 52-tone RU, a 106-tone RU, a 242-tone RU, a 484-tone RU, or a 996-tone RU.

19. The RU allocation method of claim 18, wherein determining the selected RU for being allocated to the beamformee comprises:
calculating a second average SNR of the selected RU according to the plurality of first average SNRs; and
determining the MCS index as a greatest one of a plurality of candidate MCS indices, wherein the plurality of candidate MCS indices map to a plurality of required SNRs not higher than the second average SNR.

20. The RU allocation method of claim 16, further comprising:
transmitting a frame including the selected RU, the MCS index, and the number of spatial streams to the beamformee.
